(19) United States
(12) Patent Application Publication
(10) Pub. No.: US 2026/0227218 A1
(43) Pub. Date: Aug. 6, 2026

(54) ULTRASONIC MEASURING DEVICE FOR DETERMINING THE FLOW RATE AS WELL AS A METHOD FOR DETERMINING TEMPERATURE

(71) Applicant: Levitronix GmbH, Zürich (CH)

(72) Inventor: Maciej BOBER, Penzing (DE)

(21) Appl. No.: 19/038,878

(22) Filed: Jan. 28, 2025

(30) Foreign Application Priority Data
Feb. 1, 2024 (EP) 24155240.5

(51) Int. Cl. G01F 1/667; G01F 1/66; G01K 1/02; G01K 13/02

(52) U.S. Cl. CPC G01F 1/667; G01F 1/662; G01K 1/026; G01K 13/026

(57) ABSTRACT

An ultrasonic measuring device for determining the flow rate of a fluid flowing in a line includes a measuring tube having a central axis defining a flow direction for the fluid, at least two ultrasonic transducers arranged and aligned so as to be able to exchange measurement signals with each other, with a controller to control the ultrasonic transducers and to evaluate the measurement signals, a first temperature sensor to determine a first temperature, and arranged so as to be not contacted by the fluid, and second temperature sensor to determine a second temperature arranged so as to be not contacted by the fluid.

### PRIORITY

This application claims priority to European Application No. 24155240.5, filed Feb. 1, 2024, the contents which are hereby incorporated by reference.

### BACKGROUND

### Technical Field

The disclosure relates to an ultrasonic measuring device for determining the flow rate of a fluid flowing in a line. The disclosure further relates to a method for determining the temperature of a fluid in such an ultrasonic measuring device.

### Background Information

In process engineering, non-invasive methods are used for the examination of fluids or for the measurement on fluids which flow in lines, for example in a flexible plastic tube. This is in particular the case for such highly pure or very sensitive fluids, where contact between the fluid and the measuring device should be avoided as far as possible, for example, so that the fluid is not contaminated. The pharmaceutical industry, the semiconductor industry and the biotechnology industry are mentioned here as examples. Here, solutions and suspensions are frequently produced and conveyed that place very high demands on the purity and/or the integrity of the fluid. Frequently, such fluids must even be treated under sterile conditions. Non-invasive methods are also used if the chemical resistance of the measuring device is not guaranteed.

The ultrasonic measurement technology in particular has proven its worth as a non-invasive method for measurements on fluids flowing in lines. Ultrasonic measuring devices for measurement on a fluid flowing in a line are used in particular to determine the flow rate of the fluid through a line. Typically, the ultrasonic measuring device comprises several ultrasonic transducers, which can apply ultrasonic signals to the fluid and can receive ultrasonic signals.

Inline ultrasonic measuring devices are known by which measuring systems are designated in which parts of the ultrasonic measuring device, for example a separate measuring tube, are inserted into the line through which the fluid flows, e.g., in such a way that a separate measuring tube is provided whose ends are connected to the line, so that the fluid flows out of the line into the measuring tube, flows through the measuring tube, and flows back into the line at its other end. Then, the ultrasonic measurement takes place in the area of the measuring tube. Arrangements are also known in which the measuring path, i.e., the path along which the ultrasonic transducers exchange signals with each other, extends parallel to the flow direction of the fluid in the measuring tube. In the case of such an arrangement, measurement signals are typically emitted and captured that propagate in the flow direction of the fluid, and measurement signals that propagate opposite to the flow direction. Then, the flow rate of the fluid can be determined from the transit time difference of such measurement signals. Such an ultrasonic measuring device with a measuring tube whose ends are connected to the line is described, for example, in EP 3 770 561 A1.

Furthermore, ultrasonic measuring devices are known which are designed as a clamping device. Such devices are also designated as “clamp-on” devices. Such a clamping device is designed in such a way that it can be clamped onto a flexible line so that the measuring tube of the ultrasonic measuring device encloses the line in such a way that the line is clamped in the measuring tube of the ultrasonic measuring device. The line with the fluid flowing in it is then applied with ultrasonic signals. After passing through the line and the fluid, the ultrasonic signals are received by an ultrasonic transducer and the received signal is evaluated.

### SUMMARY

For the determination of the flow rate, it is a known measure that the ultrasonic measuring device comprises at least two ultrasonic transducers, which are arranged laterally on opposite sides of the line in the operating state. The two ultrasonic transducers are arranged offset to each other with respect to the flow direction of the fluid and aligned in such a way that the first ultrasonic transducer can receive a signal emitted by the second ultrasonic transducer, and the second ultrasonic transducer can receive a signal emitted by the first ultrasonic transducer. Due to the offset to each other, the two ultrasonic transducers are aligned in such a way that they emit their ultrasonic signals obliquely to the flow direction of the fluid in each case, wherein the one ultrasonic transducer emits the signal obliquely with the flow direction, while the other ultrasonic transducer emits the signal obliquely against the flow direction. Now a measurement signal is emitted with the first ultrasonic transducer, which is received by the second ultrasonic transducer, and then a measurement signal is emitted by the second ultrasonic transducer, which is emitted by the first ultrasonic transducer.

The measurement signal emitted obliquely in the flow direction is accelerated in the flow and the measurement signal emitted obliquely against the flow direction is decelerated by the flow. The transit time difference of the two measurement signals is proportional to the flow velocity of the fluid, so that the flow rate through the flexible line can be determined from this transit time difference.

Ultrasonic measuring devices that are designed as clamping devices, in which the line through which the fluid flows, is clamped in the measuring tube of the ultrasonic measuring device, are disclosed, for example, in EP 3 489 634 A1 or also in EP 3 816 590 A1.

In ultrasonic measuring devices that are designed as a clamping device, designs are also possible in which the line is not clamped in the measuring tube but is connected to both ends of the measuring tube. This connection can be made, for example, by a barbed fitting. Then, the fluid flows from the line into the measuring tube, flows through the measuring tube and flows back again into the line at its other end.

Depending on the application, the design in which the line is connected to both ends of the measuring tube may be advantageous. In particular for measurements on very sensitive or very aggressive substances, the cleaning or sterilization of the ultrasonic measuring device is very time-consuming, material-intensive and cost-intensive. For this reason, there is often a need to design the components that come into contact with the substances, i.e., for example the measuring tube, as single-use parts for single use. In the design for single use, preferably those components which come into contact with the fluids to be treated are used exactly only once and are then replaced by new, i.e. unused, single-use parts during the next application. When manufacturing or configuring single-use parts, it is an important criterion that they can be assembled with the other components of the measuring device in the simplest possible way. It is desirable that this assembly and, of course, also the separation can be carried out with as little effort as possible, in a few steps, quickly and preferably without tools.

Regardless of the specific design of the ultrasonic measuring device, it is necessary for many applications that the temperature of the fluid in the measuring tube is known when measuring the flow rate or determining other parameters. The temperature influences many variables, such as density, speed of sound, sound refraction, sound path lengths, viscosity, friction, elastic moduli or electrical resistance. Therefore, it is often important to know the temperature of the fluid in the measuring tube. The temperature of the fluid in the measuring tube can then also be used in particular to correct the flow rate values determined by measurement or to compensate for other temperature-dependent effects. Furthermore, it is advantageous if the temperature of the fluid in the measuring tube can be made available as a process parameter.

For the reasons already mentioned, it is desirable that the temperature measurement is also carried out non-invasively. This means that a direct physical contact between the temperature sensor and the fluid should be avoided.

For a non-invasive temperature measurement on the fluid, it is proposed in EP 3 770 531 A1, for example, that a temperature sensor is provided on the outside of the wall of the measuring tube. The difference caused by the wall between the real temperature of the fluid in the measuring tube and the temperature determined by the temperature sensor is to be determined, for example by calibration measurements, so that the temperature of the fluid in the measuring tube can then be determined from the temperature determined by the temperature sensor. Furthermore, the possibility is disclosed to provide a recess on the outside of the wall of the measuring tube so that the wall there has a smaller thickness. Then, the temperature sensor can be arranged in this recess and, due to the thinner wall there, measure a temperature that is closer to the temperature of the fluid flowing in the measuring tube.

In such designs, in which the line is clamped in the measuring tube, it is even more difficult to determine the temperature accurately because the influence of the wall of the line on the temperature measurement must also be considered.

Even if this ultrasonic measuring device has proven itself in practice, it is desirable in many applications to determine the temperature of the fluid flowing in the measuring tube with greater accuracy.

Starting from this state of the art, it is therefore an object of the disclosure to propose an ultrasonic measuring device for determining the flow rate of a fluid flowing in a line, with which the temperature of the fluid can be determined with the highest possible accuracy and non-invasively. Furthermore, it is an object of the disclosure to propose a method by which the temperature of the fluid in such an ultrasonic measuring device can be determined as accurately as possible.

The subject matters of the disclosure meeting this object are characterized by the features o set forth herein.

According to the disclosure, an ultrasonic measuring device for determining the flow rate of a fluid flowing in a line is thus proposed, with a measuring tube which has a central axis defining a flow direction for the fluid, with at least two ultrasonic transducers which are arranged and aligned in such a way that they can exchange measurement signals with each other, with a control unit for controlling the ultrasonic transducers and for evaluating the measurement signals and with a first temperature sensor for determining a first temperature, which is arranged such that it cannot be contacted by the fluid. A second temperature sensor is provided for determining a second temperature, which is arranged such that it cannot be contacted by the fluid.

Due to the fact that the two temperature sensors are arranged such that they cannot be contacted by the fluid, i.e., for example next to the measuring tube, it is ensured that the two temperature sensors do not come into contact with the fluid flowing through the measuring path in the operating state. In this way, a non-invasive temperature measurement is possible.

If the temperature at two fixed measuring points is known in the ultrasonic measuring device through which the fluid flows, the temperature of the fluid in the measuring tube can be determined with a high degree of accuracy from these two temperature values.

For this purpose, according to the disclosure, a method for determining the temperature of a fluid in an ultrasonic measuring device according to the disclosure is proposed, wherein the first temperature is determined with the first temperature sensor and the second temperature is determined with the second temperature sensor. A correlation is stored in the control device which has input variables and an output variable, wherein the input variables comprise the first temperature and the second temperature, and wherein the output variable is the temperature of the fluid in the measuring tube.

This correlation, which is stored in the control unit, is determined experimentally on the basis of several measurements in which the first temperature and the second temperature are measured in each case for different known ambient temperatures and for different known temperatures of the fluid in the measuring tube. The correlation, which has the first and second temperatures as input variables and the temperature of the fluid in the measuring tube as output variable, can then be made from such measurements.

It is understood that the correlation can also have more than two input variables. For example, further temperature values can be used as input variables, e.g. determined by a third, fourth, etc. temperature sensor. Here, it is a preferred measure that the temperature sensors are arranged at locations where they are primarily influenced by different heat sources or heat sinks. For example, this is possible by arranging the different temperature sensors at different perpendicular distances from the central axis of the measuring tube, so that the temperature sensors are at different distances from the fluid flowing in the measuring tube in the operating state.

It is also possible to take other operating parameters into account in this context, for example the electrical power of the control unit, the flow rate of the fluid through the ultrasonic measuring device or the power or rotational speed of a pump with which the fluid is conveyed through the measuring tube.

The correlation between the first and second temperature and the temperature of the fluid preferably takes into account both the individual system properties, i.e. in particular the properties of the ultrasonic measuring device and of the line, and the ambient conditions, for example the ambient temperature, by which is meant the temperature of the environment in which the ultrasonic measuring device is arranged.

All heat transfers or heat transports that occur in the system made of the ultrasonic measuring device, line, environment and fluid can be taken into account in the correlation. For example, the environment can feed into or remove heat from the system. The fluid can feed into or remove heat from the system. The amount of heat transferred depends on the temperature of the fluid and its flow rate. Electrical components, such as electronic prints, which can be provided in the control unit, consume electricity, which is partly dissipated to the system as energy loss in the form of heat.

Particularly preferably, the first temperature sensor is arranged such that the first temperature is mainly, for example more than fifty percent, determined by the temperature of the fluid in the measuring tube, wherein the second temperature sensor is arranged at a location where the temperature is less dependent on the temperature of the fluid, but mainly on another heat source or heat sink of the overall system.

Preferably, the second temperature sensor for determining the second temperature is arranged such that the second temperature is representative of an ambient temperature or of a temperature of the control unit. The ambient temperature designates the temperature of the environment in which the ultrasonic measuring device is arranged. Since the ambient temperature or the control unit can represent heat sources or heat sinks, it is advantageous to determine the second temperature at a point where the second temperature is representative of the ambient temperature and/or of the temperature of the control unit.

Preferably, the first temperature sensor has a perpendicular first distance from the central axis, and the second temperature sensor has a perpendicular second distance from the central axis, wherein the second distance is greater than the first distance or is as great as the first distance. Particularly preferably, the second distance is genuinely greater than the first distance, so that the second temperature sensor is further away from the fluid than the first temperature sensor. As a consequence, the second temperature sensor is less influenced by the temperature of the fluid than the first temperature sensor.

If the first distance is as great or approximately as great as the second distance, the second temperature sensor is arranged significantly closer to a different heat source or heat sink than the first temperature sensor, for example closer to the control unit or closer to the environment. In this way, it is ensured that the second sensor is considerably more influenced by this other heat source or heat sink and thus the influence of the temperature of the fluid on the second temperature sensor is less than the influence on the first temperature sensor, even if both temperature sensors have the same perpendicular distance from the fluid.

Preferably, the first temperature sensor is arranged at the measuring tube. In this way, the first temperature is measured at a point that is close to the fluid.

In a preferred embodiment, the control unit comprises an electronic print, and the second temperature sensor is arranged at the electronic print. As a result, the second temperature is measured at a point where heat is typically generated.

In a preferred embodiment, in the operating state, the fluid flowing in the measuring tube is delimited perpendicularly to the flow direction by a wall which has a wall thickness, wherein the first temperature sensor has a perpendicular distance from the fluid in the measuring tube which is greater than or equal to the wall thickness and less than or equal to twenty times, preferably ten times, the wall thickness, or wherein the first temperature sensor is connected to the wall via a heat conducting layer. The wall which delimits the flowing fluid is the wall of the line, if the ultrasonic measuring device is designed such that the line can be inserted into the measuring tube of the ultrasonic measuring device. In embodiments in which the line is connected to the measuring tube but is not inserted into it, the wall which delimits the flowing fluid is a wall of the measuring tube.

Preferably, the ultrasonic measuring device comprises a housing in which the measuring tube and the control unit are arranged, wherein the second temperature sensor is arranged at the housing or at the control unit.

In this embodiment, the housing is preferably delimited from an environment by a housing wall, wherein the housing wall has a housing wall thickness, and wherein the second temperature sensor is arranged at a perpendicular distance from the environment, which is greater than or equal to the housing wall thickness, and less than or equal to twenty times, preferably ten times, the housing wall thickness, or wherein the second temperature sensor is connected to the housing wall via a heat conducting layer. Since the ambient temperature prevails in the environment outside the housing, and in this arrangement the second temperature is measured near the housing wall, the second temperature is representative of the temperature of the housing or the ambient temperature.

According to a preferred embodiment, the measuring tube is designed for receiving the line in such a way that the line is enclosed by the measuring tube.

Here it is particularly preferred that the ultrasonic measuring device is designed as a clamping device for a clamping connection with the line, so that the line can be clamped in the measuring tube. The ultrasonic measuring device can be designed in particular as a clamp-on device.

According to a further preferred embodiment, the measuring tube extends from a first end in the flow direction to a second end, wherein the measuring tube has a first connector at its first end, which connector is designed for connection to the line, and has a second connector at its second end, which connector is designed for connection to the line. In this embodiment, the line is thus not inserted into the measuring tube but is connected to both ends of the measuring tube. Such an embodiment is particularly advantageous if the measuring tube and possibly other components of the ultrasonic measuring device are designed as single-use parts for single use.

If the measuring tube is designed as a single-use part for single use (“single-use part”), this has various advantages. These range from the production of the measuring tube as a single-use part to the use of the measuring tube in the ultrasonic measuring device. The measuring tube is manufactured under sterile conditions according to a precisely predetermined form, template or pattern. The manufacturing process can take place by injection molding or 3D printing, for example. Other manufacturing methods are also possible. One advantage of this manufacturing method is that each single-use part produced has exactly the same dimensions or measurements and material properties. This is advantageous for the use of the single-use part in the ultrasonic measuring device.

The same measuring conditions are given for each single-use part when it is inserted into the ultrasonic measuring device, leading to the fact that a reliable and always consistent measurement, for example, of the temperature is ensured. Another advantage of the single-use part measuring tube compared to a conventional line is that due to always-the-same dimensions of the measuring tube as a single-use part, the center axis of the measuring tube always coincides with the center axis of the ultrasonic measuring device. In doing so, an overall symmetrical structure of the ultrasonic measuring device is achieved. Thus, an always-the-same enclosure of the measuring tube by the housing of the ultrasonic measuring device is also given. For example, the cross-section, i.e. the receptacle for the measuring tube, of the ultrasonic measuring device can be designed hexagonally. However, other geometric shapes of the cross-section, such as circular, oval or polygonal, are also possible.

The hexagonal cross-section of the ultrasonic measuring device ensures an increase in accuracy and resolution during measurement. Due to the hexagonal design, it is possible to measure along several measuring paths on the measuring tube or the fluid flowing in the measuring tube. As a result, for example, a higher gas bubble tolerance is achieved in the fluid during measurement with the ultrasonic measuring device.

The always-the-same enclosure of the measuring tube by the housing of the ultrasonic measuring device ensures, inter alia, that an optimal and reproducible thermal interaction between the ultrasonic measuring device and the fluid flowing through the measuring tube is made possible. When using the ultrasonic measuring device on a conventional line, such as a hose, problems can arise at the point of enclosure due to the different dimensions of the various hoses. The optimal thermal interaction, as well as the always-the-same positioning, and the always-the-same material properties of the measuring tube as a single-use part, have the effect that the temperature measurement of the medium is significantly more accurate and at the same time the response time of the measurement is increased when, for example, the temperature of the medium changes.

Another advantage of the measuring tube as a single-use part compared to a conventional flexible hose line, which is clamped in the ultrasonic measuring device, is that the measuring tube is designed to be dimensionally stable as a single-use part. This means that attaching the ultrasonic measuring device causes a slightly deformation of the measuring tube, whereas with a hose, a clamp-on ultrasonic measuring device can cause the hose to be squeezed and constricted at the point of attachment, so that, on the one hand, the fluid experiences a higher resistance than usual and, on the other hand, a measurement of, for example, the temperature is not consistent or a calibration must be carried out before each measurement for an accurate determination of the temperature.

Needless to say, that the advantages and properties of a measuring tube mentioned in the framework of this application are also applicable to a measuring tube designed as a single-use part.

With respect to the method according to the disclosure, it is preferred that the correlation, which has as an output variable the temperature of the fluid in the measuring tube, is based on a plurality of isotherms, each of which is a linear equation with a slope and an axis intercept, which equation, for a constant temperature of the fluid in the measuring tube, describes the first temperature as a function of the second temperature.

Here, it is preferred that the temperature of the fluid in the measuring tube is determined by a determination function which has exactly one variable, wherein the variable is the axis intercept of the isotherm.

Preferably, the determination function is a polynomial of at most second degree. Depending on the application, it can also be sufficient to use a straight line as a polynomial of first degree as the determining function.

In a preferred embodiment, specific offset values for the input variables are determined for the ultrasonic measuring device on the basis of the isotherms. Component tolerances, for example, can be compensated for with these offset values. For example, the temperature sensors, which are designed as thermocouples or infrared sensors, for example, are often subject to such tolerances, i.e. nominally identical components can have slight deviations from each other in practice. Such component tolerances can optionally be considered or compensated for in the method according to the disclosure.

Further advantageous measures and embodiments of the disclosure result from the dependent claims.

### BRIEF DESCRIPTION OF THE DRAWINGS

In the following, the disclosure will be explained in more detail, both in terms of apparatus and process technology, on the basis of embodiments and on the basis of the drawing. In the drawing show:

FIG. 1 is a schematic view of a first embodiment of an ultrasonic measuring device according to the invention,

FIG. 2 is a perspective view of a second embodiment of an ultrasonic measuring device according to the disclosure,

FIG. 3 is a schematic sectional view of a variant of the second embodiment,

FIG. 4 is a schematic sectional view of a further variant of the second embodiment,

FIG. 5 is a schematic sectional view of a third embodiment of an ultrasonic measuring device according to the disclosure,

FIG. 6 are three variants for the embodiment of the wall which delimits the fluid flowing in the measuring tube perpendicular to the flow direction, each in a sectional view,

FIG. 7 is a schematic sectional view of an embodiment of a housing of the ultrasonic measuring device,

FIG. 8 is a schematic view of a measuring arrangement for determining the correlation between the first and second temperature and the temperature of the fluid, and

FIG. 9-12 are various diagrams for explaining the determination of the correlation.

### DETAILED DESCRIPTION

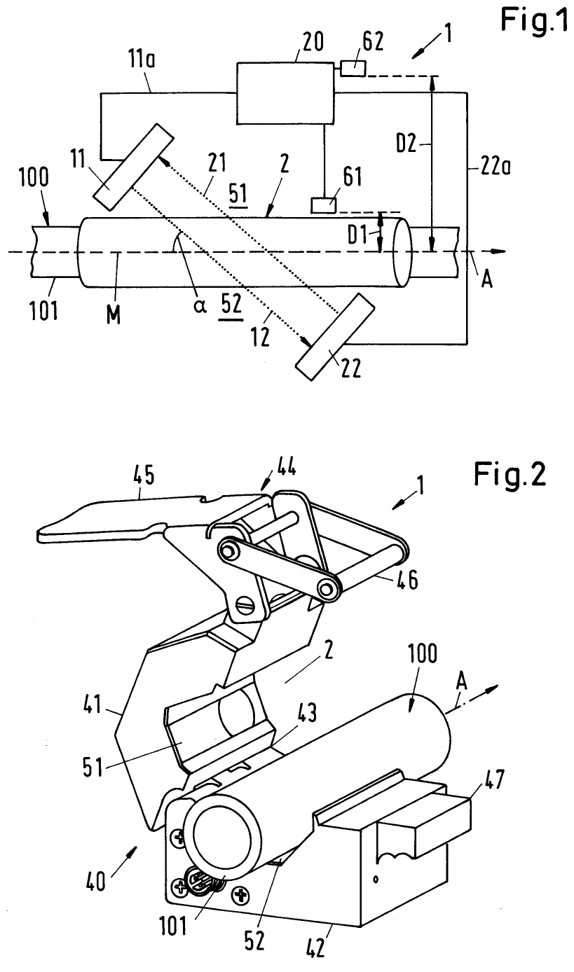

In a schematic view, FIG. 1 shows a first embodiment of an ultrasonic measuring device according to the disclosure, which is designated in its entirety by the reference sign 1. The ultrasonic measuring device 1 is designed for determining the flow rate of a fluid through a line 100. The ultrasonic measuring device 1 comprises a measuring tube 2, which has a central axis M defining a flow direction A for the fluid. In the first embodiment, the ultrasonic measuring device 1 is designed in such a way that the measuring tube 2 can receive the line 100, i.e. the line 100 can be inserted into the measuring tube 2, preferably in such a way that the line 100 is enclosed by the measuring tube 2.

In the following, reference is made to the case, which is particularly important in practice, in which the line 100 is a flexible line 100, i.e. a line 100 whose wall 101 can be deformed. The flexible line 100 is, for example, a plastic hose made of a silicone rubber or PVC. Of course, the line 100 can also be made of other materials, in particular of a plastic or a rubber. Of course, the line 100 can also be designed as a rigid, i.e. non-flexible line. Preferably, the measuring tube 2 is made of a plastic and is preferably significantly harder than the line 100 and in particular is designed to be dimensionally stable.

The fluid flows through the line 100 in the flow direction A. At least two ultrasonic transducers 11, 22 are provided for emitting and receiving measurement signals 12, 21, which are ultrasonic signals, namely a first ultrasonic transducer 11 and a second ultrasonic transducer 22. In the operating state, the first ultrasonic transducer 11 is arranged laterally on a first side 51 of the line 100, and the second ultrasonic transducer 22 is arranged laterally on a second side 52 of the line 100, wherein the second side 52 is opposite the first side 51. The ultrasonic transducers 11, 22 are arranged and aligned such that they can exchange measurement signals 12, 21 with each other. In particular, the ultrasonic transducers 11, 22 are arranged such that the first ultrasonic transducer 11 can emit a first measurement signal 12 to the second ultrasonic transducer 22 obliquely to the flow direction A of the fluid, and can receive a second measurement signal 21 emitted by the second ultrasonic transducer 22 obliquely to the flow direction A.

The measurement signals 12, 21 are each represented symbolically in FIG. 1 by dashed straight lines with an arrowhead. This is to be understood in such a way that the dashed line indicates in each case the main direction of propagation of the ultrasonic signal emitted by the corresponding ultrasonic transducer 11, 22 and the arrowhead indicates the direction, i.e. whether the respective ultrasonic signal is moving towards the respective ultrasonic transducer 11, 22, i.e. is being received, or is moving away from it, i.e. is being emitted. The main direction of propagation is usually perpendicular to the surface of the CMUT (Capacitive micromachined ultrasonic transducer) or the piezoelectric element of the corresponding ultrasonic transducer 11 or 22. The main direction of propagation includes an angle α with the flow direction A, which is different from 0° and from 90°.

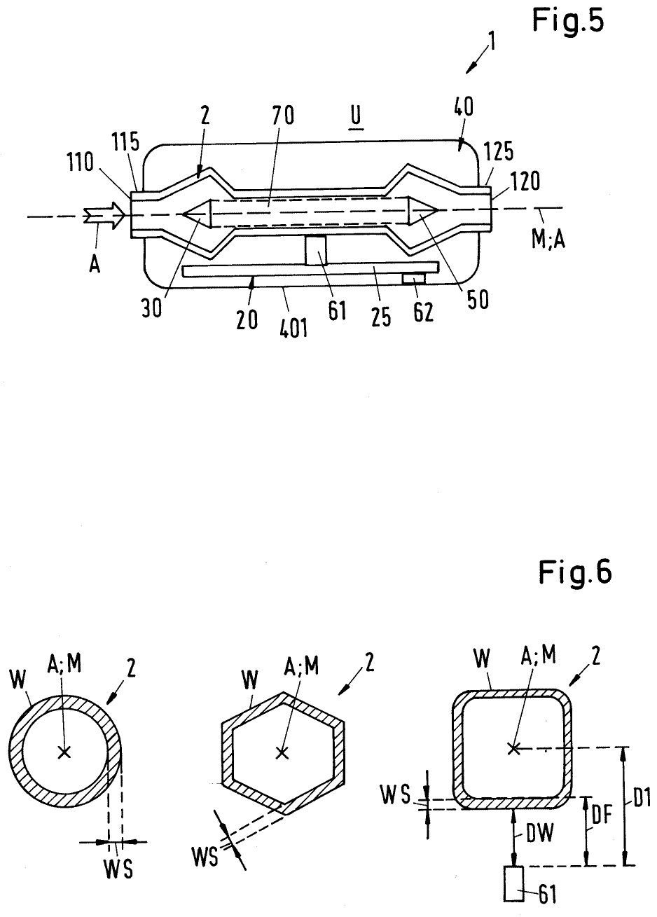

With ultrasonic measuring devices 1 that are designed as inline measuring devices (see e.g. FIG. 5), it is often the case that this angle α is equal to 0° or 180°, i.e. the measurement signals are emitted such that their main direction of propagation is equal to the flow direction A or is directed exactly opposite to the flow direction A. This can also be realized, for example, with ultrasonic measuring devices designed in a U-shape or Z-shape.

In the ultrasonic measuring device 1 represented in FIG. 1, for example, the following procedure is used to determine the flow rate of the fluid through the line 100. The first ultrasonic transducer 11 emits a first measurement signal 12, wherein the first measurement signal 12 is emitted at the angle α obliquely to the flow direction A and in the flow direction A, meaning that the main direction of propagation of the first measurement signal 12 also has a component in the flow direction A. The second ultrasonic transducer 22 emits a second measurement signal 21, wherein the second measurement signal 21 is emitted at the angle α obliquely to the flow direction A and against the flow direction A, meaning that the main direction of propagation of the second measurement signal 21 also has a component against the flow direction A.

The first measurement signal 12 is received by the second ultrasonic transducer 22 after passing through the fluid and is transmitted via a signal line 22a to a control unit 20. The second measurement signal 21 is received by the first ultrasonic transducer 11 after passing through the fluid and is transmitted via a signal line 11a to a control unit 20.

In the control unit 20, the transit time difference is determined between the first measurement signal 12, which was accelerated by the flowing fluid, and the second measurement signal 21, which was decelerated by the flowing fluid. This transit time difference between the first measurement signal 12 and the second measurement signal 21 is directly dependent on the flow velocity of the fluid in the line 100. Thus, the flow velocity and thus the flow rate of the fluid through the line 100 can be determined from the transit time difference.

It is also often the case that at least four ultrasonic transducers 11, 22 are provided in the ultrasonic measuring device 1 for the respective emitting and receiving of ultrasonic signals, namely at least two of the first ultrasonic transducers 11, which are arranged laterally on the first side 51, and at least two of the second ultrasonic transducers 22, which are arranged laterally on the second side 52. The ultrasonic transducers 11, 22 are then arranged and aligned in such a way that in each case one of the first ultrasonic transducers 11 can emit a first measurement signal 12 obliquely to and with the flow direction A to one of the second ultrasonic transducers 22, and can receive a second measurement signal 21 emitted by this second ultrasonic transducer 22 obliquely to and against the flow direction A. Then, the four ultrasonic transducers 11, 12 are arranged in the shape of an X, for example. Such an arrangement of the ultrasonic transducers 11, 22 is disclosed in EP 3 489 634 A1, for example. In this arrangement with four ultrasonic transducers, it is advantageous that two measurements are made in each case independently of each other both in the flow direction A and against the flow direction A, which significantly increases the accuracy and reliability of the determination of the flow rate. The ultrasonic measuring device 1 according to the disclosure can also be designed in the analogously same way with the arrangement of the ultrasonic transducers disclosed in EP 3 489 634 A1.

In EP 3 816 590 A1, an ultrasonic measuring device is disclosed which also comprises at least four ultrasonic transducers, wherein designs with six ultrasonic transducers are further shown. The special feature of the ultrasonic measuring device disclosed in EP 3 816 590 A1 is that measurements are taken in at least two different measuring planes, the intersection line of which is the central axis of the measuring tube. Such a design is also possible for the ultrasonic measuring device 1 according to the disclosure.

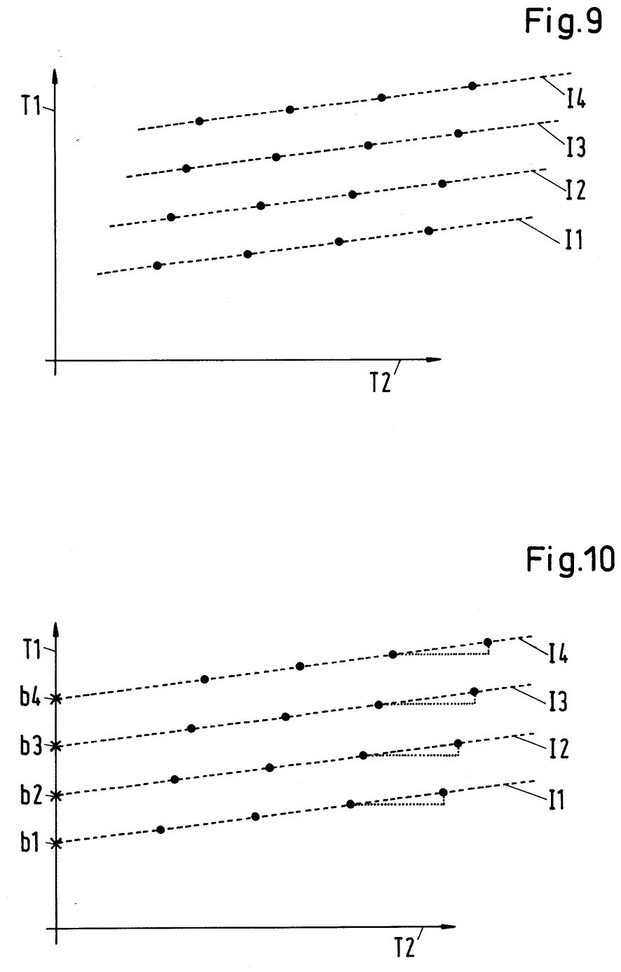

The ultrasonic measuring device 1 further comprises at least two temperature sensors, namely a first temperature sensor 61 for determining a first temperature T1 (FIG. 9), which is arranged such that it cannot be contacted by the fluid, for example next to the measuring tube 2 and has a perpendicular first distance D1 from the central axis M of the measuring tube 2, and a second temperature sensor 62 for determining a second temperature T2 (FIG. 9), which is arranged such that it cannot be contacted by the fluid, for example next to the measuring tube 2, and has a perpendicular second distance D2 from the central axis M of the measuring tube 2.

In the embodiment described here, the second distance D2 is greater than the first distance D1, which will be explained in more detail. However, such embodiments are also possible in which the first distance D1 is as great as or substantially as great as the second distance. The two temperature sensors 61, 62 are each signal-connected to the control device 20, so that the measured temperature values determined by the two temperature sensors 61, 62 can be evaluated in the control device 20.

Generally, all types of temperature sensors are suitable as temperature sensors 61, 62, for example thermocouples, thermometers, infrared (IR) sensors or other radiation sensors. In the case of non-contact types of temperature sensors 61, 62, e.g. IR sensors, the point at which the first or second temperature is determined is not the same point at which the temperature sensor 61, 62 is placed, but the measuring point at which the respective temperature sensor 61, 62 determines the temperature.

It is a substantial aspect of the disclosure that the temperature of the fluid in the measuring tube 2 can be determined non-invasively. This means that the two temperature sensors 61, 62 are arranged in such a way that they do not come into direct physical contact with the fluid flowing through the measuring tube 2. For example, the two temperature sensors 61, 62 can be arranged “next to” the measuring tube 2. Although the temperature sensors 61, 62 may rest against the measuring tube 2, for example, but they cannot be touched by the fluid flowing in the measuring tube 2.

The term “next to the measuring tube” means that the temperature sensors 61, 62 are arranged, for example, above the measuring tube 2 or below or to the right or to the left of the measuring tube 2. In embodiments in which the line 100 is inserted into the measuring tube 2 and enclosed by the latter (see also, for example, FIG. 4), the temperature sensors 61, 62 can also be arranged in the measuring tube 2, for example such that they rest against the wall 101 of the line 100. Since the wall 100 separates the temperature sensors 61, 62 from the fluid in the line 100, the temperature sensors 61, 62 cannot be contacted by the fluid even if they are arranged in the measuring tube 2.

During operation of the ultrasonic measuring device 1, the first temperature T1 and the second temperature T2 are determined in each case by the temperature sensors 61, 62. The temperature TM of the fluid in the measuring tube 2 is then determined in the control unit 20 from the first temperature T1 and the second temperature T2, as will be explained in detail later on.

Preferably, the first distance D1 is different from the second distance D2. However, embodiments are also possible in which the first distance D1 is as great or substantially as great as the second distance D2. Here, the first distance D1 is significantly smaller than the second distance D2. The first temperature T1 measured with the first temperature sensor 61 is thus measured significantly closer to the fluid than the second temperature T2 measured with the second temperature sensor 62. For this reason, the first temperature T1 measured close to the fluid is considerably more dependent on the temperature of the fluid in the measuring tube 2 or more representative of the temperature of the fluid than the second temperature T2, which is measured further away from the fluid. Based on the second temperature T2, the influence of the environment is determined, i.e. the influence of other heat sources or other heat sinks that feeds into or remove heat from the overall system made of ultrasonic measuring device 1, line 100 and fluid. Such heat sources or heat sinks can be, for example, the control device 20, which comprises electrical or electronic components that generate heat, or the environment of the ultrasonic measuring device 1, which feeds heat to the ultrasonic measuring device 1 if the ambient temperature is higher than the temperature of the ultrasonic measuring device 1, or removes heat if the ambient temperature is lower than the temperature of the ultrasonic measuring device.

Before explaining in more detail how the method for determining the temperature of the fluid in the measuring tube 2 can be carried out on the basis of the first and the second temperature T1, T2, further equipment design options for the ultrasonic measuring device 1 are first explained.

FIG. 2 shows a perspective view of a second embodiment of an ultrasonic measuring device 1 according to the disclosure.

In the following, only the differences from the first embodiment will be discussed. The same parts or parts equivalent in function of the second embodiment are designated with the same reference signs as in the first embodiment. In particular, the reference signs have the same meaning as already explained in connection with the first embodiment. It is understood that all previous explanations of the first embodiment also apply in the same way or in the analogously same way to the second embodiment.

The second embodiment of the ultrasonic measuring device 1 is designed as a clamping device, so that the line 100 can be clamped in the ultrasonic measuring device 1.

The ultrasonic measuring device 1 comprises a housing 40. The ultrasonic measuring device 1 is designed as a clamping device for a clamping connection with the line 100, i.e., the housing 40 of the ultrasonic measuring device 1 can be clamped onto the line 100 in such a way that the line 100 is fixed with respect to the housing 40. The principal design of the ultrasonic measuring device 1 with the housing 40 is known per se, for example from EP 3 489 634 A1. In EP 3 816 590 A1, an ultrasonic measuring device 1 is also disclosed which is designed as a clamping device for a detachable attachment to the line 100.

The housing 40 is designed as a closable housing 40 and comprises a first housing part 41 and a second housing part 42, which are connected to each other in an articulated manner via a joint 43. FIG. 2 shows the housing 40 in the open state. The housing 40 further has a continuous central recess, which extends through the entire housing 40 in the flow direction A and, in the closed state of the housing 40, forms the measuring tube 2 for receiving the line 100. The longitudinal extension of the central recess defines the flow direction A in which the fluid flows through the line 100 or the housing 40, respectively.

The housing 40 further has a closing mechanism 44 to close the housing 40 and thus to clamp the line 100 in the measuring tube 2. The closing mechanism 44 is arranged here at the first housing part 41 and comprises a bracket 46 and a folding strap 45 for tensioning the bracket 46. The line 100 is inserted into the measuring tube 2, then the two housing parts 41, 42 are folded together, i.e., the first housing part 41 is folded over the line 100. The bracket 46 is engaged with a projection 47 at the second housing part 42 and the two housing parts 41, 42 are tensioned together by actuating the strap 45. The housing 40 is then in its closed state, in which the line 100 is clamped in the measuring tube 2 and is thus fixed with respect to the housing 40.

In the closed state of the housing 1, the line 100 is thus fixed between the first side 51 and the second side 52, which are opposite each other with respect to the measuring tube 2.

Furthermore, a marking element (not represented) can be provided at the housing 40, for example an arrow, which defines the flow direction in which the fluid is supposed to flow through the ultrasonic measuring device 1.

The measuring tube 2 is preferably designed in such a way that it has a substantially rectangular, in particular a square cross-section perpendicular to the flow direction A in the closed state of the housing 40. This has the advantage that ultrasonic measurement signals, with which the line 100 are applied, hit planar, i.e., not curved surfaces, which greatly simplifies the detection and evaluation of the measurement signals 12, 21 and increases the accuracy of the measurement.

Embodiments are also known in which the measuring tube 2 is designed in such a way that it has a different polygonal cross-section, for example a hexagonal cross-section, perpendicular to the flow direction A in the closed state of the housing. Furthermore, embodiments are known in which this cross-section is circular or oval. In such embodiments, acoustic lenses in front of the ultrasonic transducers 11, 22 are then often used to emit and/or to receive the measurement signals 12, 21.

The ultrasonic transducers 11, 22 as well as the two temperature sensors 61, 62 are arranged inside the housing 40 and are therefore not visible in FIG. 2. The first ultrasonic transducer(s) 11 is/are arranged on the first side 51, and the second ultrasonic transducer(s) 22 is/are arranged on the second side 52.

In the second embodiment of the ultrasonic measuring device 1, embodiments with exactly two ultrasonic transducers 11, 22 are possible (analogous to the representation in FIG. 1), embodiments with exactly four ultrasonic transducers 11, 22 or embodiments with six or more ultrasonic transducers 11, 22. Preferably, at least four ultrasonic transducers 11, 22 are provided.

Each of the ultrasonic transducers 11, 22 is signal-connected to the control unit 20 via one of the signal lines 11a, 22a (analogous to FIG. 1) in each case. The signal lines 11a, 22a as well as the control unit 20 are arranged in the housing 40 and are therefore not visible in FIG. 2. Via the respective signal line 11a, 22a, the ultrasonic transducers 11, 22 are actuated to emit ultrasonic signals, and transmit the respectively received measurement signals 12, 21 to the control unit 20. The received measurement signals 12 and 21 are analyzed in the storage unit and evaluation unit 20, and the flow rate of the fluid through the line 100 is determined in each case with the aid of the measurement signals 12 and 21.

The ultrasonic transducers 11, 22 can be designed in any manner known per se, in particular as piezoelectric transducers. Typically, the frequency of the ultrasonic signals is in the megahertz range, for example in the range of 1 MHz to 30 MHz.

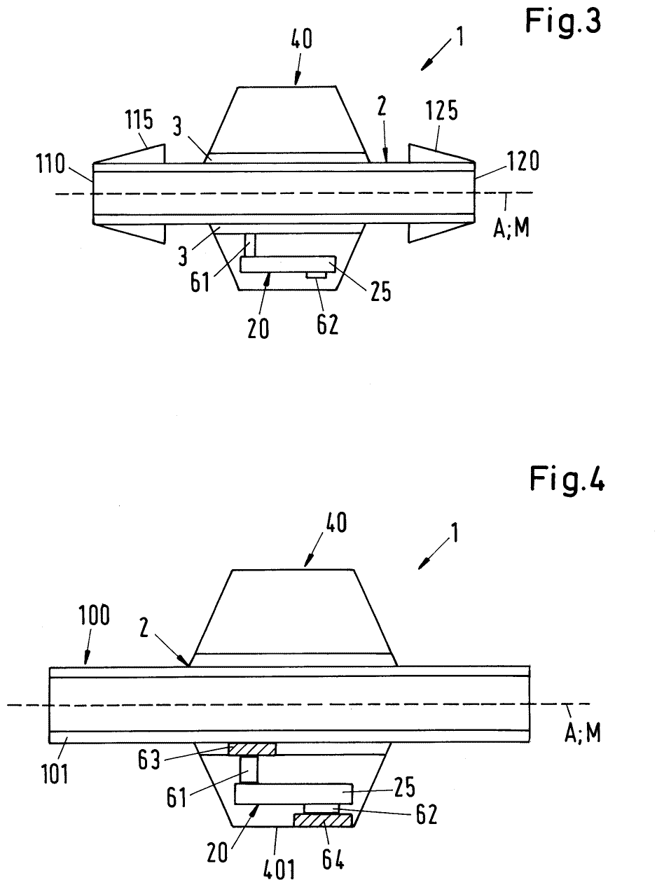

The first temperature sensor 61 and the second temperature sensor 62 are also arranged in the housing 40 and are therefore not visible in FIG. 2. However, the temperature sensors 61, 62 can, for example, be arranged as represented in FIG. 3 or FIG. 4.

In a schematic sectional view, FIG. 3 shows a variant of the second embodiment of the ultrasonic measuring device 1 according to the disclosure. In this variant, the measuring tube 2 is a separate component which is designed for connection to the line 100. In this variant, the line 100 is thus not enclosed by the measuring tube 2, but the measuring tube 2 is connected to the line 100.

The measuring tube 2 extends from a first end 110 in the flow direction A to a second end 120, wherein the length of the measuring tube 2 is dimensioned here such that both the first end 110 and the second end 120 extend out of the housing 40 of the ultrasonic measuring device 1. In other embodiments, the first end 110 and/or the second end 120 may also be arranged within the housing 40. All ultrasonic transducers 11, 22 (not represented in FIG. 3) of the ultrasonic measuring device 1 are arranged in the housing 40 with respect to the flow direction A between the first end 110 and the second end 120 of the measuring tube 2. The measuring tube 2 has a first connector 115 at its first end 110, which connector is designed for connection to the line 100 and has a second connector 125 at its second end 120, which connector is also designed for connection to the line 100. The first and the second connector 115, 125 may be designed in any configuration known per se that is suitable for connecting the measuring tube 2 to the line 100, which may in particular be designed to be flexible. In particular, the first and the second connector 115, 125 can be designed as a barbed fitting so that the line 100 can be pushed in a simple way onto the first connector 115 or the second connector 125, respectively, in such a way that the line 100 is connected to the measuring tube 2 in a sealing manner.

In a barbed fitting, a conical section is usually provided in each case at each connector 115, 125, over which the line 100, or one end of the line 100, is pulled or pushed. This conical section is usually provided with one or more rib(s), which are not represented in the schematic representation of FIG. 3, but can of course be provided in a manner known per se.

The measuring tube 2 is inserted into the ultrasonic measuring device 1 in the analogously same way as explained above for the line 100 on the basis of FIG. 2, when the housing 40 is in the open state. After the measuring tube 2 has been inserted into the ultrasonic measuring device 1, the housing 40 is brought into its closed state, in which the measuring tube 2 is clamped and thus fixed with respect to the housing 40. A holder 3 can be provided in the ultrasonic measuring device, which firmly encloses the measuring tube 2 in the closed state of the housing 40, so that the measuring tube 2 is fixed in the housing 40.

In the embodiment with the separate measuring tube 2, which is inserted into the ultrasonic measuring device 1 and fixed in it, the measuring tube 2 can be designed in particular as a single-use component for single use.

The measuring tube 2 is manufactured under sterile conditions according to a precisely predetermined form, template or pattern. The manufacturing process can take place by injection molding or 3D printing, for example. Other manufacturing methods are also possible. One advantage of this manufacturing method is that each single-use part produced has exactly the same dimensions or measurements. This has the advantage that when inserting the measuring tube 2 in the housing 40 of the ultrasonic measuring device 1 the same measuring conditions are given, leading to the fact that a reliable and always consistent measurement, for example, of the temperature is ensured. Another advantage of the single-use part measuring tube 2 compared to a line 100 is that due to always-the-same dimensions of the measuring tube 2 as a single-use part, the center axis M of the measuring tube 2 coincides with a center axis of the ultrasonic measuring device 1. In doing so, an overall symmetrical structure of the ultrasonic measuring device 1 is achieved. This means that the ultrasonic measuring device 1 has a symmetrical structure, which ensures that an always-the-same enclosure of the measuring tube 2 by the housing 40 of the ultrasonic measuring device 1 is given.

Due to the symmetrical structure of the housing 40 of the ultrasonic measuring device 1, a complete enclosure of the measuring tube 2 is achieved. This leads to the fact that an as large as possible contact surface between the measuring tube 2 and the ultrasonic measuring device 1 is achieved. Due to this symmetrical and concentric structure, uniform thermal conditions are achieved in the ultrasonic measuring device 1. This means that thermal processes (e.g. temperature profile) can be described relatively easily using mathematical relationships based on the symmetries present in the structure of the ultrasonic measuring device 1 and thus, for example, the temperature profile depending on the thickness of the wall of the measuring tube 2, for example, can be easily calculated without making substantial changes to the underlying mathematical calculation models. Thus, isotherms, i.e. positions at which the same thermal conditions prevail, can be determined, which leads to the fact that, for example, the positioning of the temperature sensors can be easily varied. This is particularly true when the temperature sensors are varied on an isotherm, i.e. between positions with the same temperature.

Conversely, however, it can also be seen that it is not trivial at which position in the ultrasonic measuring device 1 the temperature should be measured so that it can serve as an input variable for a calculation model.

The simpler variation of the temperature sensors in the ultrasonic measuring device 1 increases, inter alia, the flexibility of the ultrasonic measuring device 1 in terms of the range of applications, as well as the velocity of the measurements and also the adaptation of the measurement to new circumstances.

A further advantage of the symmetrical structure is that the thermal conditions in the ultrasonic measuring device 1 are not provided with additional temperature gradients. As a result, uneven thermal conditions in the ultrasonic measuring device 1 are avoided. This not only has the advantage that the measurements are more accurate, but also that the influence on the measuring tube 2 and thus also on the fluid flowing in it is reduced. Otherwise, due to the occurrence of additional temperature gradients, mechanical tension could arise, for example, and thus possibly damage of sensitive fluids and/or their components.

In order to be able to implement this desired symmetry of the ultrasonic measuring device 1, the cross-section, i.e. the receptacle for the measuring tube 2 of the ultrasonic measuring device 1, can be designed hexagonally (see FIG. 6). However, other geometric shapes of the cross-section, such as circular, oval or polygonal, are also possible.

The hexagonal cross-section of the ultrasonic measuring device 1 ensures an increase in accuracy and resolution during measurement. Due to the hexagonal design, it is possible to measure along several measuring paths on the measuring tube 2 or the fluid flowing in the measuring tube 2. As a result, for example, a higher gas bubble tolerance is achieved in the fluid during measurement with the ultrasonic measuring device 1.

The always-the-same enclosure of the measuring tube 2 by the ultrasonic measuring device 1 ensures, inter alia, that an optimal and reproducible thermal interaction between the ultrasonic measuring device 1 and the fluid flowing through the measuring tube 2 is made possible. When using the ultrasonic measuring device 1 on a line 100, such as a hose, problems can arise at the point of enclosure due to the different dimensions of the various lines 100. The optimal thermal interaction, as well as the always-the-same positioning and the always-the-same material properties of the measuring tube 2 as a single-use part, have the effect that the temperature measurement of the fluid is significantly more accurate and at the same time the response time of the measurement is increased when, for example, the temperature of the fluid changes.

Another advantage of the measuring tube 2 as a single-use part compared to a line 100, which is clamped in the ultrasonic measuring device 1, is that the measuring tube 2 is designed to be dimensionally stable as a single-use part. This means that attaching the ultrasonic measuring device 1 causes less deformation of the measuring tube 2, whereas with a hose as line 100, for example, a clamp-on ultrasonic measuring device can cause the hose to be squeezed and constricted at the point of attachment, so that, on the one hand, the fluid experiences a higher resistance than usual and, on the other hand, a measurement of, for example, the temperature is not consistent or a calibration must be carried out before each measurement for an accurate determination of the temperature.

In FIG. 3, the control device 20 is also represented, with which the ultrasonic transducers 11, 22 are controlled and with which the measurement signals 12, 21 received by the ultrasonic transducers 11, 22 are evaluated. Preferably, the control device 20 comprises an electronic print 25, which is also designated as PCB (printed circuit board), and on which electronic and/or electrical components of the control device 20 are arranged.

In particular, the arrangement of the two temperature sensors 61, 62 is also represented in FIG. 3. The first temperature sensor 61 is arranged close to the measuring tube 2, so that the first temperature T1 measured by it is determined very close to the fluid flowing in the measuring tube 2. The second temperature sensor 62 is arranged at the control unit 20, for example on the electronic print 25, so that the second temperature T2 determined by the second temperature sensor 62 is representative of the temperature of the control unit 20. It is understood that both temperature sensors 61, 62 are signal-connected to the control unit 20.

In a schematic sectional view, FIG. 4 shows a further variant of the second embodiment of the ultrasonic measuring device 1 according to the disclosure. This variant is designed, in the analogously same way as shown in FIG. 2, in such a way that the line 100 is inserted into the measuring tube 2 so that the line 100 is clamped in the measuring tube 2 in the closed state of the housing 40.

The first temperature sensor 61 is arranged at the measuring tube 2 and is connected to the wall 101 of the line 100 via a heat conducting layer 63. The second temperature sensor 62 is arranged at the control device 20, in this case on the electronic print 25, and is connected via a heat conducting layer 64 to a housing wall 401, which delimits the housing 40. Due to the arrangement of the second temperature sensor 62 at the housing wall 401, the second temperature T2 is representative of the ambient temperature, by which is meant the temperature of the environment in which the housing 40 is arranged. The heat conducting layer 63 ensures a particularly good thermal coupling between the line 100 or the measuring tube 2 on the one hand and the first temperature sensor 61 on the other hand. The heat conducting layer 64 ensures a particularly good thermal coupling between the housing 40 and the second temperature sensor 62.

The heat conducting layers 63 and 64 can be designed in any manner known per se. For example, the heat conducting layers 63, 64 can be realized with a thermal potting compound into which the respective temperature sensor 61, 62 is cast. The heat conducting layers 63, 64 can also be realized, for example, with thermal pads, with heat conducting pastes or with paints with good thermal conductivity. Of course, it is also possible that the first temperature sensor 61 rests directly against the wall 101 of the line 100. Furthermore, it is possible that the second temperature sensor 62 rests directly against the housing wall 401.

In general, it is preferred for the arrangement of the two temperature sensors 61, 62 if the difference between the first distance D1 and the second distance D2 is as great as possible. The first temperature sensor 61 is preferably arranged as close as possible to the fluid, while the second temperature sensor 62 is arranged as close as possible to the housing 40 and/or to the control unit 20 or is thermally coupled as well as possible to the housing 40, so that the second temperature T2 represents the ambient temperature well.

FIG. 5 shows a schematic sectional view of a third embodiment of an ultrasonic measuring device 1 according to the disclosure.

In the following, only the differences from the two first embodiments will be discussed. The same parts or parts equivalent in function of the third embodiment are designated with the same reference signs as in the two first embodiments. In particular, the reference signs have the same meaning as already explained in connection with the two first embodiments. It is understood that all previous explanations also apply in the same way or in the analogously same way to the third embodiment.

In the third embodiment, the measuring tube 2 is designed as a separate component that can be inserted into the housing 40 of the ultrasonic measuring device 1 and can fixed there, for example by a clamping connection. Apart from the two temperature sensors 61, 62, the basic structure of the ultrasonic measuring device 1 or the measuring tube 2 of the third embodiment corresponds to the devices which are disclosed in EP 3 770 561 A1.

In the third embodiment, the measuring tube 2, which has the central axis M, extends from the first end 110 in the flow direction A to the second end 120, wherein the length of the measuring tube 2 is dimensioned such that both the first end 110 and the second end 120 extend out of the housing 40 of the ultrasonic measuring device 1. All ultrasonic transducers 11, 22 (not represented in FIG. 3) of the ultrasonic measuring device 1 are arranged in the housing 40 with respect to the flow direction A between the first end 110 and the second end 120 of the measuring tube 2. Then, the measuring tube 2 has a first connector 115 at its first end 110, which is designed for connection to the line 100, and a second connector 125 at its second end 120, which is also designed for connection to the line 100. The first and the second connector 115, 125 may be designed in any configuration known per se which is suitable for connecting the measuring tube 2 to the line 100, which may in particular be designed to be flexible. The fluid enters the measuring tube 2 through the first connector 115, and the fluid leaves the measuring tube 2 through the second connector 125.

A first chamber 30 is provided, in which the first ultrasonic transducer 11 (not represented) is arranged, as well as a second chamber 50, in which the second ultrasonic transducer 22 (not represented) is arranged. The first ultrasonic transducer 11 and the second ultrasonic transducer 22 delimit a rectilinear measuring path 70 for the fluid. The first chamber 30 and the second chamber 50 are designed and arranged such that the fluid can flow around each of them. The first ultrasonic transducer 11 and the second ultrasonic transducer 22 are arranged such that the measuring path 70 extends in the flow direction A.

In the third embodiment, the ultrasonic sensors 11, 22 are thus designed in such a way that the measurement signals 12, 21 propagate parallel to the flow direction A. The main direction of propagation of the measurement signals 12, 21 thus encloses an angle of 0° or 180° with the flow direction A. As a consequence, the measurement signals 12, 21 are emitted in such a way that their main direction of propagation is equal to the flow direction A or exactly opposite to it.

In the third embodiment of the ultrasonic measuring device 1 according to the disclosure, the first chamber 30 is designed on its side facing the first connector 115 in such a way that it divides the fluid flow as gently as possible into two partial flows, when viewed in flow direction A, one of which is guided around above the first chamber 30 according to the representation, and the other of which is guided around below the first chamber 30 according to the representation. For this purpose, the first chamber 30 has, for example, a triangular cross-section when viewed in flow direction A. Due to this configuration, the fluid is divided into two substantially equally strong partial flows.

Preferably, the second chamber 50 is designed on its side facing the second connector 125 in such a way that it brings the two partial flows together again as gently as possible behind the second chamber 50 when viewed in flow direction A. For this purpose, the second chamber 50 has, for example, a triangular cross-section when viewed in flow direction A.

For further details of this embodiment of the ultrasonic measuring device, reference is made to EP 3 770 561 A1.

The two temperature sensors 61, 62 and the control device 20 are arranged in the housing 40, wherein the first temperature sensor 61 is arranged close to the fluid and the second temperature sensor 62 is arranged close to the housing 40.

Of course, such embodiments are also possible and preferred in which the measuring tube 2 is arranged rotated by 90° about its central axis M with respect to the representation in FIG. 5.

As already explained, the first temperature sensor 61 is preferably arranged close to the fluid, so that the first temperature T1 depends primarily, but not only, on the temperature of the fluid in the measuring tube 2. The second temperature sensor 62 is arranged considerably further away from the fluid, preferably at the control unit 20, e.g. on the electronic print 25, and/or at the housing wall 401 of the housing 40. Thus, the second temperature T2 is strongly dependent on environmental influences, in this case on the temperature on the electronic print 25 and/or the temperature of the housing 40, more precisely the housing wall 401, which in turn is strongly dependent on the ambient temperature, i.e. on the temperature of the environment U in which the ultrasonic measuring device 1 is placed.

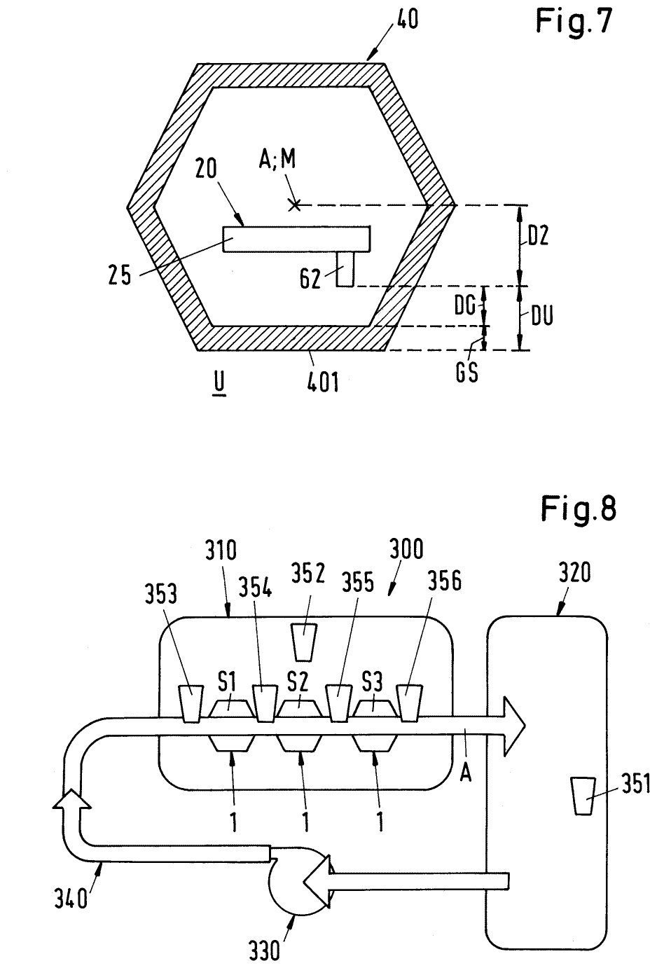

In the following, preferred areas for the first distance D1 (FIG. 6) and the second distance D2 (FIG. 7) are explained with reference to FIG. 6 and FIG. 7.

In the operating state of the ultrasonic measuring device 1, the fluid flowing in the measuring tube 2 is delimited perpendicular to the flow direction A by a wall W. Depending on the embodiment, this wall W is the wall 101 of the line 100, or a wall which delimits the measuring tube 2. In embodiments in which the line 100 is inserted into the measuring tube 2 (see, e.g., FIG. 2, FIG. 4), the wall W delimiting the fluid is the wall 101 of the line 100. In embodiments in which the line 100 is connected to the ends 110, 120 of the measuring tube 2 (see, e.g., FIG. 3, FIG. 5), the wall W delimiting the fluid is a wall of the measuring tube 2. The following explanations apply to both embodiments. Thus, the wall delimiting the fluid is designated with the reference sign W, which wall is the wall 101 of the line 100, or the wall of the measuring tube 2.

In FIG. 6, three variants for the design of the wall W are shown, which delimits the fluid flowing in the measuring tube 2 perpendicular to the flow direction A. The cross-sectional area represented in each case perpendicular to the flow direction A can be predetermined, for example by the profile of the line 100 or the measuring tube 2, or it can be forced by the ultrasonic measuring device 1, for example if the line is clamped in the ultrasonic measuring device 1 and its cross-sectional area is deformed as a result.

In the left-hand variant according to the representation in FIG. 6, the wall W is designed with a ring-shaped profile, in particular a circular ring-shaped profile. In the middle variant according to the representation, the wall W is designed with a hexagonal profile. In the right-hand variant according to the representation, the wall W is designed with a rectangular profile, in particular a square profile, wherein the corners of the rectangle or square are preferably rounded. It is understood that the profiles represented in FIG. 6 are preferred profiles but are of exemplary character. However, other profiles are possible, for example n-cornered profiles, wherein n is a natural number other than four or six.

The wall W has a wall thickness WS, which means the extension of the wall W in the direction perpendicular to the flow direction A. The first temperature sensor 61, which has the first distance D1 from the central axis M, has a perpendicular distance DF from the fluid and a perpendicular distance DW from the wall W. The distance DF of the first temperature sensor 61 from the fluid is thus the sum DW+WS, i.e. the sum of the distance of the first temperature sensor 61 from the wall W and the wall thickness WS.

It is preferred that the first temperature sensor 61 is arranged such that its perpendicular distance DF from the fluid in the measuring tube 2 is greater than or equal to the wall thickness WS and less than or equal to twenty times, preferably ten times, the wall thickness WS.

Particularly preferably, the first temperature sensor 61 is arranged at the wall W so that its distance DW from the wall W is zero. In this case, the distance DF of the first temperature sensor 61 from the fluid is equal to the wall thickness WS.

If it is not possible or not desirable, for example due to the construction, to arrange the first temperature sensor 61 directly at the wall W, so that the distance DW is greater than zero, it is preferred, as already explained in connection with FIG. 4, to connect the first temperature sensor 61 to the wall W via the heat conducting layer 63. Materials with good thermal conductivity, for example metallic materials such as aluminum or copper, thermal pads or a heat-conducting paste, are particularly advantageous for the heat conducting layer 63.

On the basis of FIG. 7, preferred arrangements of the second temperature sensor 62 are now described. FIG. 7 shows a schematic sectional view of an embodiment of the housing 40 of the ultrasonic measuring device 1 with the housing wall 401, which delimits the housing 40 with respect to an environment U. Since it is sufficient for understanding, only the control device 20 with the electronic print 25 as well as the second temperature sensor 62 for determining the second temperature T2 are represented in FIG. 7 in addition to the housing 40.

The housing wall 401 has a housing wall thickness GS, at least in the area that is arranged adjacent to the second temperature sensor 62, by which is meant the extension of the housing wall 401 between the interior of the housing 40 and the environment U. The second temperature sensor 62 is arranged, for example, on the electronic print 25 of the control device 20. The second temperature sensor 62 is arranged at a vertical distance DU from the environment U. The second temperature sensor 62 has a perpendicular distance DG from the housing wall 401, more precisely from the inside of the housing wall 401. The perpendicular distance DU of the second temperature sensor 62 from the environment U, i.e. the space outside the housing 40, is thus the sum DG+GS, i.e. the sum of the distance DG of the second temperature sensor 62 from the inside of the housing wall 401 and the housing wall thickness GS.

It is preferred that the second temperature sensor 62 is arranged such that its perpendicular distance DU from the environment U is greater than or equal to the housing wall thickness GS and less than or equal to twenty times, preferably ten times, the housing wall thickness GS.

Particularly preferably, the second temperature sensor 62 is arranged at the housing wall 401, more precisely at the inside of the housing wall 401, so that its distance DG from the inside of the housing wall 401 is equal to zero. In this case, the distance DU of the second temperature sensor 62 from the environment U is equal to the housing wall thickness GS.

If it is not possible or not desired, for example due to the construction, to arrange the second temperature sensor 62 directly at the inside of the housing wall 401, so that the distance DG is greater than zero, it is preferred, as already explained in connection with FIG. 4, to connect the second temperature sensor 62 to the housing wall 401 via the heat conducting layer 64. Materials with good thermal conductivity, for example metallic materials such as aluminum or copper, thermal pads or a heat-conducting paste, are particularly advantageous for the heat conducting layer 64.

Another possibility for arranging the second temperature sensor 62 as close as possible to the environment U is to reduce the housing wall thickness GS of the housing wall 401 at that point where the second temperature sensor 62 is arranged. For example, a blind hole can be provided in the housing wall 401 into which the second temperature sensor 62 is inserted. It is also possible to reduce the housing wall thickness GS of the housing wall 401 to zero at that point where the second temperature sensor 62 is arranged, so that the second temperature sensor 62 has direct physical contact with the environment U. For this purpose, for example, a bore can be provided in the housing wall 401 which extends completely through the housing wall 401. The second temperature sensor 62 can then be inserted into this bore. The perpendicular distance DU of the second temperature sensor 62 from the environment U is then zero. Of course, the temperature measurement of the fluid remains non-invasive because the second temperature sensor 62 does not come into direct physical contact with the fluid in the measuring tube 2 due to this optional measure.

Furthermore, a method for determining the temperature of a fluid in an ultrasonic measuring device 1 according to the disclosure is proposed by the disclosure. In this method, the first temperature T1 is determined with the first temperature sensor 61 and the second temperature T2 is determined with the second temperature sensor 62. A correlation is stored in the control device 20, which has input variables and an output variable. The input variables of the correlation comprise the first temperature T1 and the second temperature T2. The output variable of the correlation is the temperature of the fluid in the measuring tube 2, which is designated TM.

In the following, an embodiment of the method according to the disclosure is explained, wherein in particular the determination of the correlation which is stored in the control unit 20 of the ultrasonic measuring device 1 is considered.

In a schematic view, FIG. 8 shows an embodiment of a measuring arrangement 300 which is suitable for determining the correlation between the first temperature T1, the second temperature T2 and the temperature TM of the fluid in the measuring tube 2 or line 100.

The measuring arrangement 300 comprises a climatic chamber 310, a tempering device 320, a pump 330, a circulation line 340, as well as a plurality of temperature sensors 351, 352, 353, 354, 355, 356 for determining the temperature at different points of the measuring arrangement 300.

A predeterminable, constant temperature TU can be set in the climatic chamber 310, which is monitored by the temperature sensor 352. The temperature TU in the climatic chamber simulates the ambient temperature.

In the tempering device 320, the fluid is tempered to a predeterminable temperature TM of the fluid. The predeterminable temperature TM to which the fluid is tempered in the tempering device 320 can be monitored by the temperature sensor 351.

In the climatic chamber 310, a plurality of ultrasonic measuring devices 1 designed according to the disclosure, in this case three ultrasonic measuring devices 1, are arranged in series one behind the other. The three ultrasonic measuring devices 1 are all designed in the same manner. In principle, a single ultrasonic measuring device 1 in the climatic chamber 310 is also sufficient, but the accuracy of the correlation to be determined can be improved with several identical ultrasonic measuring devices 1 because, for example, component tolerances of the ultrasonic measuring device 1 are averaged out. All ultrasonic measuring devices 1 are arranged in series in the climatic chamber 310, i.e. one behind the other. In each of the ultrasonic measuring devices 1, the first temperature sensor 61 for detecting the first temperature T1 and the second temperature sensor 62 for detecting the temperature T2 are arranged in each case. The temperature sensors 61, 62 are not represented in FIG. 8.

Furthermore, several temperature sensors 353, 354, 355, 356 are arranged in the climatic chamber 310 at the circulation line 340 to monitor the temperature of the fluid in the circulation line 340. Preferably, one temperature sensor 353, 354, 355 is arranged in each case upstream of each ultrasonic measuring device 1 in the climatic chamber 310, when viewed in flow direction A, and one temperature sensor 356 is arranged downstream of the last ultrasonic measuring device 1.

The tempering device 320, the pump 330 and the climatic chamber 310 are connected by the circulation line 340 to form a flow circuit through which the fluid is circulated by the pump 330.

The fluid is tempered in the tempering device 320 to the predeterminable temperature TM and circulated by the pump 330 through the circulation line 340 and the climatic chamber 310 back into the tempering device 320. In the climatic chamber 310, the fluid flows through the three ultrasonic measuring devices 1 one after the other, wherein the first temperature T1 and the second temperature T2 are determined in each case in each of the ultrasonic measuring devices 1 by the temperature sensors 61, 62 (not represented). If—as shown in FIG. 8—several ultrasonic measuring devices 1 are arranged in the climatic chamber 310, the mean value of the first temperatures T1 measured by the various first temperature sensors 61 or the second temperatures T2 measured by the various second temperature sensors 62 is used in each case for an individual measurement for the first temperature T1 or for the second temperature T2, respectively.

For an individual measurement, the temperature TM of the fluid is set by the tempering unit, while the temperature TU, which simulates the ambient temperature, is set in the climatic chamber 310. The temperature sensors 351-356 primarily serve to monitor exact conditions during the measurements.

Since the thermal influence of the fluid on the ultrasonic measuring devices 1 cannot and should not be neglected, it is preferred that the fluid is circulated with a volume or a volume flow of the fluid at which the interaction between the fluid and the ultrasonic measuring devices 1 is ensured to a noticeable extent. In practice, it has been shown that a minimum volume flow of the fluid of 100 ml/min is sufficient. Of course, the size of the advantageous volume flow depends on the design and in particular on the size of the ultrasonic measuring device 1. Depending on the specific design or size of the ultrasonic measuring device 1, it is preferred that the volume flow of the fluid is in the range of 500 ml/min to 5000 ml/min. It has been shown that the volume flow of the fluid does not need to be varied for a reliable determination of the correlation. In particular, if the volume flow of the fluid is at least as high as the preferred minimum value of 100 ml/min, a constant, stable and largely flow-independent heat exchange results between the ultrasonic measuring device 1 and the fluid.

For the determination of the correlation between the first temperature T1, the second temperature T2 and the temperature TM of the fluid in the measuring tube 2 or line 100, different measurements are now carried out, which are carried out at different temperatures TM of the fluid and at different temperatures TU in the climatic chamber 310, which simulate different ambient temperatures. Here, the variation of the temperature TM of the fluid is made by the tempering device 320 and the variation of the temperature TU by the climatic chamber 310.

In principle, the two temperatures TM and TU can be varied as desired. However, it is advantageous if the temperatures TM and TU cover the range in which the ultrasonic measuring device 1 is to work later in operation. For example, if the fluid is water or a water-like liquid, it is preferred to vary the temperature TM of the fluid between about 2° C. and 90° C. If the medium of the environment U is air, it is preferred to vary the temperature TU in the range from 5° C. to 60° C.

After the temperature TM of the fluid or the temperature TU in the climatic chamber 310 has been set to a new value after an individual measurement, sufficient time is waited before the next individual measurement until the entire system of the measuring arrangement 300 has settled and is thermally stable.

A plurality of isotherms I1, I2, I3, I4 is now determined by several individual measurements. As an example, FIG. 9 shows a plurality of four isotherms I1, I2, I3 and I4. In FIG. 9, the second temperature T2 determined by measurement, which was determined by the second temperature sensors 62 of the ultrasonic measuring devices 1 is plotted on the horizontal axis. As already mentioned, the respective measured value of T2 is the mean value of the three values of T2 that were determined in the various ultrasonic measuring devices 1. The first temperature T1 determined by measurement, which was determined by the first temperature sensors 61 of the ultrasonic measuring devices 1, is plotted on the vertical axis. As already mentioned, the respective measured value of T1 is the mean value of the three values of T1 that were determined in the various ultrasonic measuring devices 1. In FIG. 9, the black dots on the isotherms I1-I4 indicate the values of T1 and T2 determined by measurement.

On each isotherm I1-I4, the temperature TM of the fluid is constant in each case, and the four different dots belong to different values of TU. This means that an isotherm I1 or I2 or I3 or I4 is determined by keeping the temperature TM of the fluid at a constant value and setting the temperature TU in the climatic chamber 310 to different values—in this case four different values. Each isotherm I1-I4 thus indicates the dependence of the first temperature T1 on the second temperature T2 when the temperature TM of the fluid is kept constant, and the temperature TU is varied.

For example, the isotherm I1 belongs to the constant temperature TM of 10° C., the isotherm I2 to the constant temperature TM of 20° C., the isotherm I3 to the constant temperature TM of 30° C. and the isotherm I4 to the constant temperature TM of 40° C.

The four measuring points on each of the isotherms I1-I4 belong—from left to right in FIG. 9—to the values 10° C., 20° C., 30° C. and 40° C. for the temperature TU, for example.

Of course, these numerical values are only to be understood as examples and serve to explain how the desired correlation is determined.

For a constant temperature TM of the fluid, all measuring points lie on a straight line in each case, i.e. each isotherm I1-I4 can be represented as a straight line of the form

$$T 1 = a \cdot T 2 + bt$$

wherein a is the slope of the straight line and bt is the axis intercept where the respective straight line intersects the vertical axis.

It has been shown that for all temperatures TM of the fluid, the associated isotherms I1, I2, I3, I4 each have the same slope a, i.e. all isotherms I1-I4 are parallel. This can also be recognized in FIG. 9. Thus, the various isotherms I1-I4 differ only in their axis intercept bt, which depends on the temperature TM to which the respective isotherm I1-I4 belongs. The slope a, which each of the isotherms I1-I4 has, is therefore a constant that depends on the respective ultrasonic measuring device 1. This constant must be determined anew for each embodiment of the ultrasonic measuring device 1 but is then always the same for ultrasonic measuring devices 1 of the same construction.

Once the individual isotherms I1-I4 have been determined, preferably in such a way that the entire desired working range of the ultrasonic measuring device 1 is covered, the axis intercepts bt of the isotherms I1-I4 are determined. This is represented in FIG. 10. The associated axis intercept bt is determined for each isotherm I1-I4. The various axis intercepts are designated b1, b2, b3 and b4, wherein b1 is the axis intercept of the isotherm I1 and thus belongs to the temperature TM of the fluid at which the isotherm I1 was determined. In the analogous way, b2 belongs to the isotherm I2, b3 to the isotherm I3 and b4 to the isotherm I4.

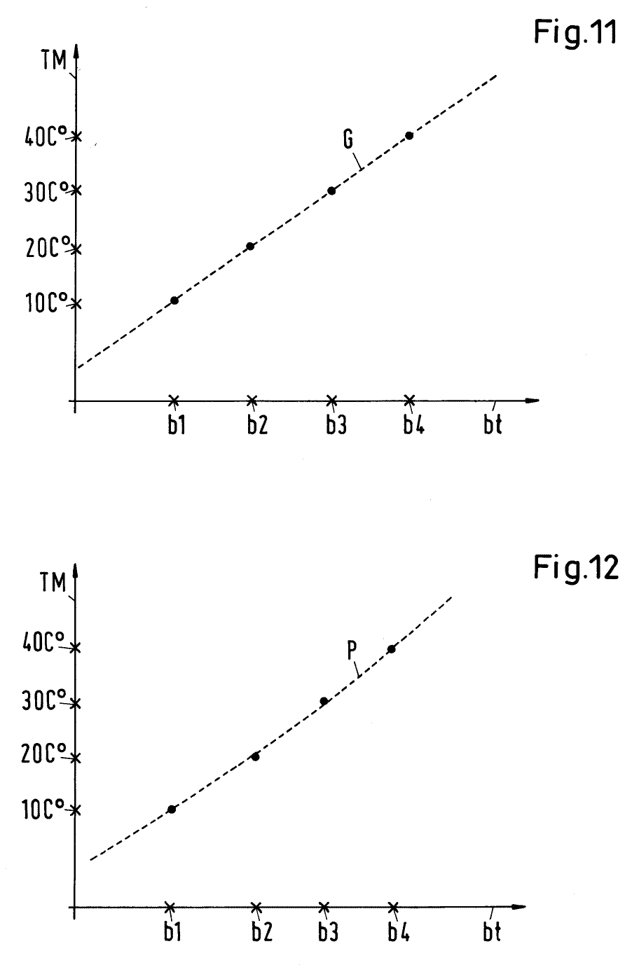

Now the correlation between the temperature TM of the fluid and the axis intercepts bt is determined. In FIG. 11 and FIG. 12, the axis intercepts bt of the isotherms I1-I4 are plotted in each case on the horizontal axis and the temperature TM of the fluid to which the respective axis intercept bt belongs is plotted on the vertical axis. These are the four pairs of values represented as black dots in FIG. 11 and FIG. 12.

From these pairs of values TM, bt, a determination function is now determined which describes the temperature TM of the fluid in dependence on the axis intercepts bt. Thus, the determination function has exactly one variable, namely the axis intercept bt of the isotherm.

In practice, it has been shown that it is sufficient for many applications if the determination function is a polynomial of at most second degree. Of course, it is also possible to use an polynomial of nth degree, with n greater than two for the determination function.

In FIG. 11, the determining function is a straight line G, i.e. a polynomial of first degree, wherein the straight line G is described by the following function:

$$TM = E \cdot bt + F$$

In FIG. 12, the determining function is a quadratic function P, i.e. polynomial of second degree, which is described by the following function:

$$TM = E \cdot {bt}^{2} + F \cdot bt + H$$

The coefficients E, F and possibly H can be determined by means of approximation methods known per se.

Like the slope a, the coefficients E, F and H are model constants that depend on the respective ultrasonic measuring device 1. The coefficients E, F and possibly H must be determined anew for each embodiment of the ultrasonic measuring device 1 but are then always the same for ultrasonic measuring devices 1 of the same construction.

With the coefficients E, F and possibly H as well as the slope a, the correlation is now known which has the first temperature T1 and the second temperature T2 as input variables and the temperature TM of the fluid in the measuring tube as output variable.

If the first temperature T1 and the second temperature T2 are now determined in the operating state of the ultrasonic measuring device by means of the two temperature sensors 61, 62, the axis intercept bt first can be calculated by means of the isotherm equation:

$$b t = T 1 - a \cdot T 2$$

Subsequently, the temperature TM of the fluid in the measuring tube 2 can be determined with high accuracy by means of the linear determination function

$$TM = E \cdot bt + F$$

or by the quadratic determination function

$$TM = E \cdot {bt}^{2} + F \cdot bt + H$$

Thus, in the operating state of the ultrasonic measuring device 1, the temperature TM of the fluid in the measuring tube can be determined very precisely from the temperatures determined by measurement, namely the first temperature T1 and the second temperature T2. In the process, this reliable temperature determination is non-invasive, i.e. none of the temperature sensors 61, 62 comes into direct physical contact with the fluid which flows through the measuring tube 2 or the line 100.

Optionally, the input variables of the correlation, namely the first temperature T1 and the second temperature T2, can be subjected to a correction. Since the various components, such as the temperature sensors 61, 62, which are designed for example as thermocouples or infrared sensors, or components for current measurement or voltage measurement, which are designed for example as integrated circuits, may be subject to component tolerances, it may be advantageous to adjust such component tolerances.

This adjustment is preferably carried out on the basis of the isothermal equation

$$b t = T 1 - a \cdot T 2$$

by allowing offset values T1off and T2off for the temperatures T1 and T2, which are constant values for the specific ultrasonic measuring device 1.

The isotherm equation is then

$$b t = ( T 1 - T 1 off ) - a \cdot ( T 2 - T 2 off )$$

In this way, component tolerances in the temperature sensors 61, 62 in particular can be adjusted.

It is understood that such embodiments of the method according to the invention are also possible in which the correlation, whose output variable is the temperature TM of the fluid in the measuring tube 2, has still other input variables in addition to the first temperature T1 and the second temperature T2, for example additional temperatures, e.g. the temperature of the environment or electrical operating variables or other operating parameters.

1. An ultrasonic measuring device for determining the flow rate of a fluid flowing in a line, comprising:
a measuring tube having a central axis defining a flow direction for the fluid;
at least two ultrasonic transducers arranged and aligned to exchange measurement signals with each other;
a controller configured to controller the ultrasonic transducers and to evaluate the measurement signals;
a first temperature sensor configured to determine a first temperature, and arranged so as to be not contacted by the fluid; and
a second temperature sensor configured to determine a second temperature, and arranged so as to be not contacted by the fluid.

2. The ultrasonic measuring device according to claim 1, wherein the first temperature sensor has a perpendicular first distance from the central axis, the second temperature sensor has a perpendicular second distance from the central axis, and the second distance is greater than the first distance or is as great as the first distance.

3. The ultrasonic measuring device according claim 1, wherein the first temperature sensor is arranged at the measuring tube.

4. The ultrasonic measuring device claim 1, wherein the controller comprises an electronic print, and the second temperature sensor is arranged at the electronic print.

5. The ultrasonic measuring device according to claim 1, wherein in an operating state the fluid flowing in the measuring tube is delimited perpendicularly to the flow direction by a wall having a wall thickness, and the first temperature sensor has a perpendicular distance from the fluid in the measuring tube which is greater than or equal to the wall thickness and less than or equal to twenty times the wall thickness, or the first temperature sensor is connected to the wall via a heat conducting layer.

6. The ultrasonic measuring device according to claim 1, further comprising a housing in which the measuring tube and the controller are arranged, and the second temperature sensor is arranged at the housing or at the controller.

7. The ultrasonic measuring device according to claim 6, wherein the housing is delimited from an environment by a housing wall, the housing wall has a housing wall thickness, and the second temperature sensor is arranged at a perpendicular distance from the environment, perpendicular distance is greater than or equal to the housing wall thickness, and less than or equal to twenty times the housing wall thickness, or the second temperature sensor is connected to the housing wall via a heat conducting layer.

8. The ultrasonic measuring device according to claim 1, wherein the measuring tube is configured to receive the line such that the line is enclosed by the measuring tube.

9. The ultrasonic measuring device according to claim 8, wherein the ultrasonic measuring device is a clamping device to provide clamping connection with the line, so that the line is capable of being clamped in the measuring tube.

10. The ultrasonic measuring device according to claim 1, wherein the measuring tube extends from a first end in the flow direction to a second end, the measuring tube has a first connector at the first end, the first connector being configured to connect to the line, and having a second connector at a second end, the second connector being configured to connect to the line.

11. A method for determining the temperature of a fluid in an ultrasonic measuring device according to claim 1, comprising:
determining the first temperature with the first temperature sensor;
determining the second temperature with the second temperature sensor;
storing a correlation in the controller which has input variables and an output variable, the input variables comprising the first temperature and the second temperature, and the output variable is a temperature of the fluid in the measuring tube.

12. The method according to claim 11, wherein the correlation is based on a plurality of isotherms, each isotherm of the plurality of isotherms is a linear equation with a slope and an axis intercept, each equation, when the temperature of the fluid in the measuring tube is constant, describes the first temperature as a function of the second temperature.

13. The method according to claim 12, wherein the temperature of the fluid in the measuring tube is determined with a determination function having exactly one variable, the variable being the axis intercept of a respective isotherm.

14. The method according to claim 13, wherein the determining function is a polynomial of at most second degree.

15. The method according to claim 12, wherein specific offset values for the input variables are determined for the ultrasonic measuring device on the basis of the plurality of isotherms.

16. The ultrasonic measuring device according to claim 1, wherein in an operating state the fluid flowing in the measuring tube is delimited perpendicularly to the flow direction by a wall having a wall thickness, and the first temperature sensor has a perpendicular distance from the fluid in the measuring tube which is greater than or equal to the wall thickness and less than or equal to ten times the wall thickness, or the first temperature sensor is connected to the wall via a heat conducting layer.

17. The ultrasonic measuring device according to claim 6, wherein the housing is delimited from an environment by a housing wall, the housing wall has a housing wall thickness, and the second temperature sensor is arranged at a perpendicular distance from the environment, perpendicular distance is greater than or equal to the housing wall thickness, and less than or equal to ten times the housing wall thickness, or the second temperature sensor is connected to the housing wall via a heat conducting layer.
